(19) United States
(12) Patent Application Publication
(10) Pub. No.: US 2026/0366911 A1
(43) Pub. Date: Nov. 19, 2026

(54) SYSTEM AND METHOD FOR HIGH-PRECISION, HIGH-FREQUENCY, REMOTE SENSING OF VIBRATIONS OF A SURFACE USING MULTI-FEATURE ANALYSIS OF REFLECTED LIGHT SIGNALS TO ENHANCE EASE OF USE

(71) Applicant: ConcurrentData, Inc., Brighton, MI (US)

(72) Inventors: Mark RAUCHFUSS, Birmingham, MI (US); Stephen COOPER, Fowlerville, MI (US); Karl SLAMA, Sunnyvale, CA (US)

(73) Assignee: ConcurrentData, Inc., Brighton, MI (US)

(21) Appl. No.: 19/678,285

(22) Filed: May 15, 2026

Related U.S. Application Data
(60) Provisional application No. 63/806,824, filed on May 16, 2025.
(60) Provisional application No. 63/911,032, filed on Nov. 4, 2025.

(51) Int. Cl. G01H 9/00; G01B 11/16

(52) U.S. Cl. CPC G01H 9/002; G01B 11/167

(57) ABSTRACT

A non-contact method is presented for measuring vibrations of a surface of an object with an observation system. The method includes: positioning an observation system proximate to the surface of the object, where the observation device is configured to measure vibration of the surface using one or more primary light sources and includes at least one ancillary light source for alignment; projecting an alignment pattern onto the surface of the object using the at least one ancillary light source; and adjusting position of the observation system in relation to the surface of the object based on the alignment pattern projected onto the surface of the object.

### CROSS-REFERENCE TO RELATED APPLICATIONS

This application claims the benefit of U.S. Provisional Application No. 63/806,824, filed on May 16, 2025, and U.S. Provisional Application No. 63/911,032, filed on Nov. 4, 2025. The entire disclosure of each of the above applications is incorporated herein by reference.

### FIELD

The present disclosure relates to a non-contact system and method for measuring vibrations or oscillations on a surface of an object at high frequency with high precision without physically contacting the target surface. For example, the system and method may be used for measurement in a frequency range up to 10 kilohertz or more at 5 cm standoff and for measurement of amplitudes of less than 50 nanometers.

### BACKGROUND

Conventional methods of measuring surface oscillations of an object or structure under test typically rely on physically attaching piezoelectric sensors to the surface of the object. There are a number of undesirable effects and dependencies resulting from physical attachment of these sensors to the surface of the object. The process of configuring these systems is laborious and time-consuming, and the direct attachment can affect the physical and acoustical behavior of the surface, resulting in inaccurate characterization of surface oscillations. Therefore, it is desirable to develop detection systems that can stand off a considerable distance from the target surface while measuring the vibrations.

An alternate means for measuring vibrations or oscillations is to illuminate the surface with one or more narrow light beams, and to determine the spatial and temporal correlations of changes of position and orientation of the surface at those locations by observing changes in the pattern of reflected light.

The use of reflected light to measure various characteristics and behaviors of surfaces has a very extensive history. In addition to simple physical observation the techniques used to analyze surface motion and other characteristics include interferometry, vibrometry (Doppler shift), intensity or color variation, and triangulation. Most of the currently available light-based detection systems are extremely expensive and many of them need to be placed in very close proximity (2 centimeters) to the surfaces under investigation.

The systems described in this disclosure rely to some extent on triangulation-based optical detection methods. However, these systems go beyond simply measuring the movement of the image of reflected light across a detector. They analyze multiple statistical and geometric features of the reflected light signal in order to extract the maximum amount of information from it.

The enhancements achievable with these techniques can increase measurement precision, make the systems easier to use, eliminate potential problems, and extract additional useful information.

This section provides background information related to the present disclosure which is not necessarily prior art.

### SUMMARY

This section provides a general summary of the disclosure, and is not a comprehensive disclosure of its full scope or all of its features.

In one aspect, a non-contact sensing method for measuring vibrations of a surface of an object with an observation system is presented. The method may include positioning an observation system proximate to the surface of the object, where the observation device may be configured to measure vibration of the surface using one or more primary light sources and may include at least one ancillary light source for alignment. The method may further include projecting an alignment pattern onto the surface of the object using the at least one ancillary light source. The method may further include adjusting position of the observation system in relation to the surface of the object based on the alignment pattern projected onto the surface of the object.

In another aspect the alignment pattern may further be defined as a central point having a number of lines emanating from the central point.

In another aspect, the alignment pattern may further be defined as a polygon generated by three or more ancillary light sources.

In another aspect, the position of the observation system may be adjusted by an operator of the observation system.

In another aspect, adjusting position of the observation system may include detecting the alignment pattern reflected by the surface of the object using at least one detector associated with the observation system; comparing the detected alignment pattern to an expected alignment pattern; and automatically adjusting position of the observation system based on the comparison of the detected alignment pattern to the expected alignment pattern.

In another aspect, the method may further include generating at least one of an audible indicator or a visible indicator in response to alignment of the observation system with the surface of the object.

In another aspect, the method may further include projecting light from the one or more primary light sources towards an area of interest on the surface of an object, where the light projected from the one or more light sources may be incident on at least one point on the surface of the object. The method may further include detecting the light reflected by the surface of the object using one or more detectors associated with the observation system. The method may further include, for each of the one or more detectors, determining a change in position of the reflected light detected by the detector over time. The method may further include, for the at least one point on the surface of the object, calculating a series of measurements of vertical displacement of the surface over a period of time from the change in position of the reflected light and using triangulation. The method may further include determining frequency of a disturbance of the surface of the at least one point on the surface and an amplitude of the disturbance using the series of measurements of vertical displacement.

In another aspect, the method may include projecting light from a first primary light source and a second primary light source of the one or more primary light sources towards an area of interest on the surface of an object, where the light projected from the one or more light sources may converge at a predefined distance, so as to accurately and precisely determine a distance between the area of interest on the surface of the object and the observation system.

In another aspect, the alignment pattern may be projected onto the surface of the object using the one or more primary light sources and the at least one ancillary light source.

In a second aspect, an observation system for measuring vibrations of a surface of an object is presented. The observation system may include one or more primary light sources configured to measure vibration of the surface of the object. The observation system may further include at least one ancillary light source configured to project an alignment pattern onto the surface of the object. The observation system may further include at least one adjustment mechanism configured to adjust position of the observation system in relation to the surface of the object based on the alignment pattern projected onto the surface of the object.

In another aspect, the alignment pattern of the observation system may be defined as a central point having a number of lines emanating from the central point.

In another aspect, the alignment pattern of the observation system may be defined as a polygon generated by three or more ancillary light sources.

In another aspect, the adjustment mechanism of the observation system may be configured to be adjusted by an operator of the observation system.

In another aspect, the observation system may further comprise at least one detector configured to detect the alignment pattern reflected by the surface of the object. The adjustment mechanism may be configured to automatically adjust position of the observation system based on a comparison of the detected alignment pattern to an expected alignment pattern.

In another aspect, the adjustment mechanism of the observation system may further comprise at least one of an audible indicator or a visible indicator. The audible indicator and the visible indicator may be configured to be activated in response to alignment of the observation system with the surface of the object.

In another aspect, the observation system may further comprise one or more detectors configured to detect light produced by the one or more primary light sources and reflected by the surface of the object, such that a change in position of the reflected light detected by each of the one or more detectors is determined. The observation system may further comprise at least one processor configured to calculate a series of measurements of vertical displacement of the surface over a period of time from the change in position of the reflected light, and the at least one processor may further be configured to determine frequency of a disturbance of the surface at one or more points on the surface and an amplitude of the respective disturbance using the series of measurements of vertical displacement.

In another aspect, a first primary light source of the observation system and a second primary light source of the observation system may each be configured to project light toward an area of interest on the surface of the object. The projected light from each of the first primary light source and the secondary light source may converge at a predefined distance, so as to determine a distance between the area of interest on the surface of the object and the observation system.

In another aspect, the alignment pattern may include light from the one or more primary light sources and the at least one ancillary light source.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow chart illustrating a non-contact method of measuring vibrations or oscillations on a surface according to an example embodiment.

FIG. 2A is a diagram illustrating a setup for conducting the method of FIG. 1 according to an example embodiment.

FIG. 2B is a diagram illustrating an alternative setup for conducting the method of FIG. 1 according to an example embodiment.

FIG. 2C is a diagram illustrating a setup for conducting the method of FIG. 1 measuring multiple points of displacement according to an example embodiment.

FIG. 2D is a diagram illustrating a setup for conducting the method of FIG. 1 including multiple ancillary light sources for positioning the observation system according to an example embodiment.

FIG. 2E is a diagram illustrating a tilt of an observation system according to an example embodiment.

FIGS. 3A-3E illustrate a series of example light patterns that may be projected on a target surface using an observation system for the method of FIG. 1 according to at least one example embodiment including the effects of the observation system being tilted at a wrong angle or located at a wrong distance.

FIGS. 4A-4G illustrate a series of example light patterns on a surface being recognized at various angles while conducting the method of FIG. 1 according to at least one example embodiment.

FIG. 5 illustrates an observation system for conducting the method of FIG. 1 in which multiple light sources are used according to an example embodiment.

FIG. 6 illustrates an observation system for conducting the method of FIG. 1 in which multiple detectors are used according to an example embodiment.

Corresponding reference numerals indicate corresponding parts throughout the several views of the drawings.

### DETAILED DESCRIPTION

Example embodiments will now be described more fully with reference to the accompanying drawings.

Some terms used throughout this disclosure are defined as follows. Target surface refers to the surface under investigation (SUI). Vertical is to be understood as the direction that is perpendicular to the principal plane of the target surface, where this direction is also designated as being parallel to the z-axis. The principal plane is defined as the plane that is most closely parallel to the general orientation of a tangent plane to the target surface at the point of measurement. For example, the principal plane of a perfectly flat surface would be the plane in which that surface lies, such that the coordinate axes for the principal plane are labeled ‘x’ and ‘y’. The base plane is defined as follows: it is a plane that is parallel to the principal plane; in other words, it is essentially parallel to the target surface, where a line between the emitter (light source) and the detector lies in the base plane. More specifically, the base plane passes through the lens of the detector.

By projecting a narrow light beam onto a target surface and creating a localized spot of light on the surface and observing the motion of the illuminated spot, it is possible to determine the motion of the surface in the vertical (z) direction (as defined above). It is also possible, in some circumstances, to track disturbances that propagate across the surface. Motion in the z direction can be measured by capturing the reflected light beam with a lens or other focusing device that produces an image of the illuminated spot in a specific region on a photo-sensitive surface (detector), such as a charge-coupled device (CCD). (It is readily understood that other types of light detectors also fall with the scope of this disclosure.) The movement of the spot across the detector corresponds to movement of target surface in the z direction.

This disclosure describes several innovations in both hardware and software of the types of optical sensing systems described above. These innovations make it possible to measure the amplitude of vibrations more precisely, to accurately measure vibrations at high frequencies (up to 10 kilohertz and beyond), and to do so with observation devices that can stand off the target surface at distances greater than 5 centimeters (thus making them easier to use and preventing any interference with the motion of the surface). The proposed observation devices are also substantially less expensive than most alternatives. It should be noted that additional advantages not explicitly disclosed herein may be present without straying from the scope of the present disclosure.

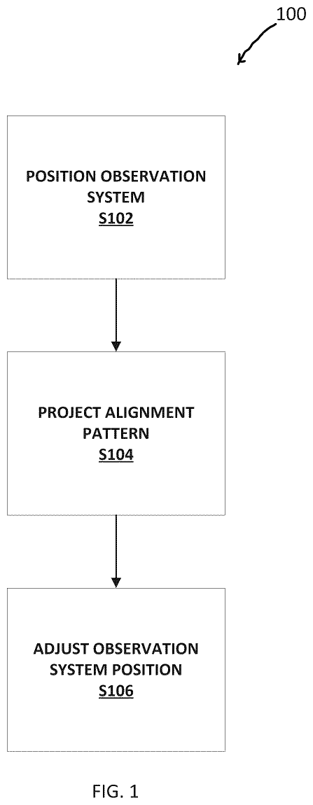

FIG. 1 illustrates a flow chart for a non-contact method of measuring vibrations or oscillations on a target surface. Method 100 includes at least a first step S102, a second step S104, and a third step S106.

At step S102, an observation system is positioned proximate to the surface of an object, in which the surface is the target surface to be measured. The observation system is configured at least to measure vibrations, or oscillations, of the surface using one or more primary light sources and at least two ancillary light sources. The combination of light sources is primarily used to properly align the observation system. In at least one example embodiment, the observation system used in method 100 includes at least a primary light source, at least two ancillary light sources, and a detector. The primary light source is configured to project a light onto a target surface of the object being measured. The at least two ancillary light sources are configured to measure alignment of the observation system relative to the target surface. The detector is configured to receive light reflected from the target surface, where the light being reflected to the detector is the light projected from the primary light source. It should be understood that the observation system being utilized for method 100 may vary in exact size, shape, and configuration of the light sources and the detector. Further, the exact number of light sources and detectors may vary in alternative embodiments.

An essential feature for operation of the optical observation system is to control the alignment relative to the target surface, specifically, the angle relative to the z-axis and/or the distance along it between the observation system and the target surface. Direct measurements with rulers and protractors are awkward to make and are difficult to achieve with desired precision. At step S104, the combination of light sources is used to project an alignment pattern onto the surface of the object where the pattern will have a specific size and shape at correct alignment and progressively deviate from it at incorrect alignment. Any number of patterns may be utilized in aligning the observation system. The more distinct features of the alignment pattern that are provided, the more deviations from proper alignment will be recognizable. Example alignment patterns are further described below in relation to additional figures.

At step S106, the position of the observation system is adjusted in relation to the surface of the object, the adjustment being based on the alignment pattern projected onto the surface in S104, and the detection of any deviations from the proper alignment.

The adjustment of the observation system may be done manually or automatically. In a manual configuration, an operator of the observation system may look at the alignment of the projected light pattern on the surface compared to an ideal pattern configuration. The operator will then adjust the system so as to align with the ideal pattern configuration.

In at least one example embodiment, a series of audio and/or visual feedback presentations will be made for the operator to interpret. For example, in at least one embodiment, a series of tones are sounded by the observation system based on the current alignment compared to an ideal alignment. In such embodiment, a frequency of beeps, chirps, or other tones will sound. When the alignment is significantly off, the frequency will be slower. As the alignment is corrected toward the ideal position, the frequency of sounds will increase until finally a solid tone is presented when the observation system is properly aligned. Different tones may be utilized to represent different scenarios. For example, different pitch tones and/or volumes may be presented in order to signal different required changes, such as axis tilt, rotation, or distance from the observation system to the surface.

In another example embodiment, voice commands may be presented to the operator. For example, the observation system may call out specific directions and corrections to be made, such as angles along at least one axis, and/or rotation of the system, and/or distance from the observation system to the surface.

In addition to, or in place of, the audio feedback components described above, visual feedback may also be presented to an operator of the observation system. For example, the lights associated with the pattern may flash at specific frequencies to signal accuracy of the current alignment. Similar to the frequency of tones described above, a slow frequency of flashing light may indicate a significant misalignment, with the frequency increasing as the position gets closer to an ideal alignment, and finally being a solid light when properly aligned. Additionally, variation in color may be utilized in at least one example embodiment.

At least one example embodiment may include a display screen in which alignment directions and status are indicated. For example, a computer monitor, laptop screen, or other display device may provide a visual indication of the current position and any corrections that may be necessary to the system alignment. The visual indication may be purely graphical, such as showing a picture of the current position compared to the ideal position. The visual indication may further indicate textual information, such as instructions for alignment correction and/or measurement data indicating the exact quantitative data related to the observation system alignment.

In at least one example embodiment, an automated system is utilized for adjusting the position of the observation system. The automated system may include a camera or other imaging system, such as a 2D camera. The imaging system will view the current alignment, and an associated processor may compare the current image to an ideal alignment. The processor, or other processing equipment, will then coordinate operation of a servo motor, or other similar device configured for adjusting the position of the observation system.

One technique for analyzing the alignment patten to infer current position of the system is a machine vision system. Machine vision is an automated feature configured for recognizing visual data, similar to how a human eye sees visual information which is then processed by the brain. The machine vision recognizes patterns, such as deviation in alignment from an ideal position of the observation system and may make adjustments accordingly. For example, the machine vision will relay to the servo motor, or other machine manipulating technology, the exact movements that need to occur to align the observation system correctly. It can also provide information for audio or visual feedbacks to a human operator. Some machine vision techniques, such as edge detection, circle detection, and spot detection may be utilized in analyzing the position of the observation system. However, it should be understood that alternative embodiments may utilize additional, or varying, techniques without straying from the scope of the present disclosure.

In at least one example embodiment, a joint manual and automatic operation may occur, in which there are both manual and automatic aspects described above integrated into a single system. In such embodiment, the integration of manual and automatic systems may be for either coordinated effort purposes to work in tandem, or as a form of redundancy for system operation. For example, the manual adjustment could be to get the observation system in approximate alignment to bring the pattern into the field of view of the 2D camera, and then have machine vision feedback to the manual or automated system for final more precise alignment. Each of the above-described manual and automated systems for adjusting position of the observation system may be defined as an adjustment mechanism. Each type of adjustment mechanism may include additional components not specifically listed herein without straying from the scope of the present disclosure.

Described below are systems and system setups which may be utilized in conducting method 100. It should be noted that additional example embodiments not explicitly described herein may be utilized in method 100 without straying from the scope of this disclosure.

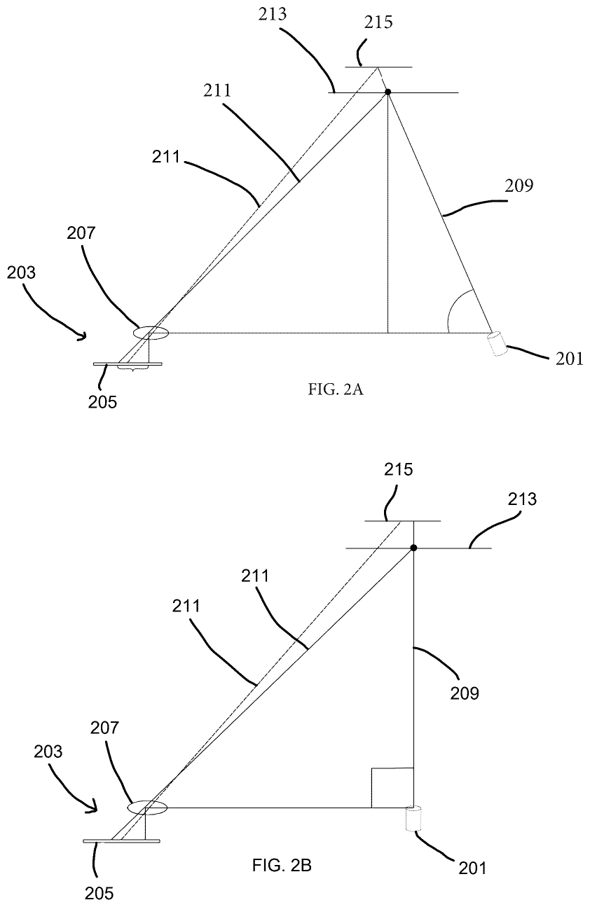

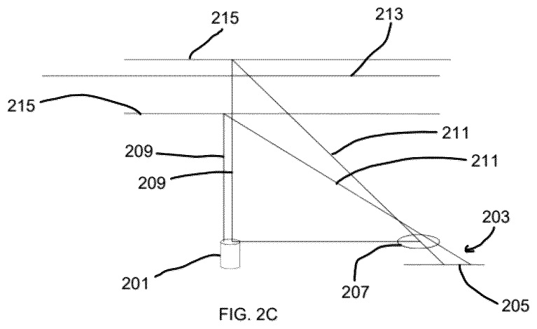

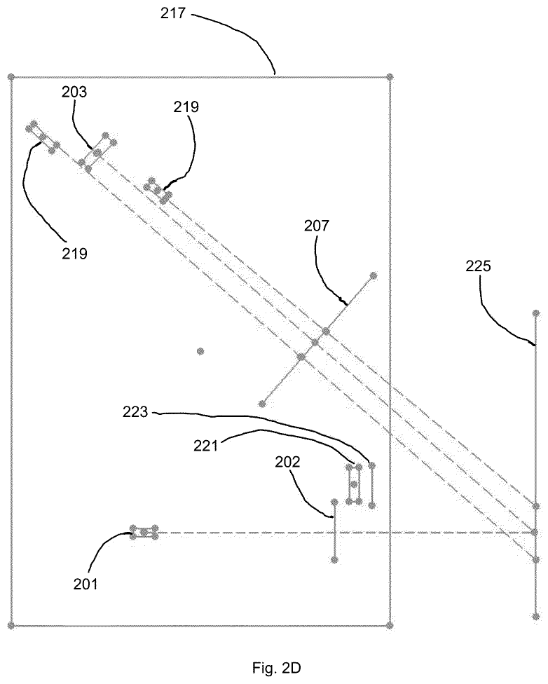

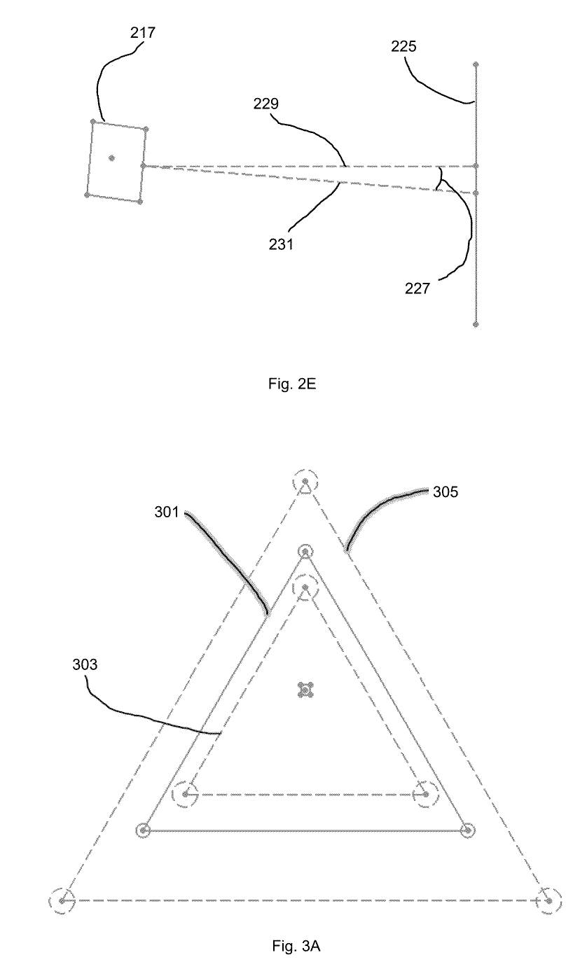

FIGS. 2A-2C illustrate a series of example setups for an observation system configured to conduct method 100. Light 209 is projected by a light source 201 along a projection axis toward a point of interest on a surface of the object. Light 211 reflected by the surface is in turn detected by a light detector 203. In one example, the light source 201 is further defined as a laser and the light detector 203 is further defined as a charge-coupled device (CCD). It is readily understood that other types of light detectors also fall with the scope of this disclosure.

To calculate vertical displacement of the surface at the point of interest, the light detector 203 is interfaced with a processor. The processor determines a change in position of the reflected light 211 detected by the detector 203. From the change in position (shown in FIGS. 2A-2C as the difference in position between surface 213 and surface 215), the vertical displacement of the surface can be calculated using triangulation. The calculation method for determining the amplitude of vibrations for a particular configuration depends on the geometric and trigonometric relationships of the observing device(s) to the target surface.

For the arrangement illustrated in FIG. 2A the change in displacement in the z-direction, dz, is calculated as follows:

dz=[(i*s)−zd]/[(d+(i*cotangent(Θ)))],

where d is distance between where the reflected light 211 is incident on the detector 203 and a reference point on the detector 203, i is distance between the detector chip 205 and receiving lens 207 associate therewith, z is length of an altitude of a triangle when the object is not subject to external forces, s is distance between the light source (emitter) 201 and the center of the detector lens 207 (s is also referred to herein as the baseline), and Θ is the angle between the projection axis and a base plane, such that a line between the light source 201 and the detector 203 lies in the base plane, the base plane is parallel to the surface of the object, and the triangle is formed by the light source 201, the detector 203 and the point of interest on the surface of the object. More specifically, d is the distance measured between where the reflected light 211 is incident on the detector 203 and the point on the detector 203 directly aligned with center of the detector lens 207.

FIG. 2B shows a different possible configuration of an observing system in which the emitter 201 is directly aligned with the point of interest on the surface of the object. That is, Θ is 90 degrees, such that cotangent(Θ)=zero, thereby simplifying the equation for computing vertical displacement, the simplified equation being:

dz=[(i*s)/d]−z.

Other arrangements for aligning the light source 201 and/or the emitter in relation to the object surface are also contemplated by this disclosure. It is understood that the specific trigonometric formula for each configuration is dependent on the particular geometric relationships and is readily derivable by a practitioner skilled in the art.

The dominant frequency components can be analyzed using a combination of techniques. One of these is illustrated in FIG. 2C, which shows a temporal sequence of displacement observations where the time between maximum positive and negative displacements is recorded as a reference. This is used in conjunction with standard Fourier analysis techniques to determine the principal frequency components and to reconstruct the temporal sequence of oscillations by matching the superposed frequencies to the maximum displacements. This is implemented by shifting the phase relationship among the dominant frequency components until the displacement peaks (shown at point 215 relative to point 213) match those observed in the original signal and applying standard correlation test frequencies to the maximum displacements. This is implemented by shifting the phase relationship among the dominant frequency components until the displacement peaks 215 match those observed in the original signal, and applying standard correlation tests.

In order to report oscillations of the surface, the light detector 203 is configured to capture changes in light position at up to 10,000 or more frames per second. This non-contact approach does not affect the physical and acoustical behavior of the surface of the object. Furthermore, this approach is unsusceptible to high temperatures, high temperature gradient, and exposure to extreme electrostatic and electromagnetic interference.

In one example, the processor is implemented as a microcontroller. It should be understood that the functions performed by the processor can be implemented in hardware logic, software logic, or a combination of hardware and software logic. In this regard, the processor can be, or can include any of, a digital signal processor (DSP), microprocessor, microcontroller, or other programmable device which are programmed with software implementing the above-described methods. It should be understood that, alternatively, the processor is or includes other logic devices, such as a Field Programmable Gate Array (FPGA), a complex programmable logic device (CPLD), or application specific integrated circuit (ASIC). When it is stated that the processor performs a function or is configured to perform a function, it should be understood that processor is configured to do so with appropriate logic (such as in software, logic devices, or a combination thereof).

FIG. 2D illustrates an example of observation system 217 being utilized to view a target surface 225. Observation system 217 includes a light source 201 projecting a light through a light source lens 202 and then onto a target surface 225. System 217 further includes multiple ancillary light sources 219 projecting light onto the target surface 225. Together, the light source 201 and ancillary light sources 219 project an alignment pattern onto the target surface 225, such that the alignment pattern can be utilized to verify that observation system 217 is in the proper position. Example alignment patterns are shown in further figures and described below. A camera 221 having a camera lens 223 may be utilized to view the alignment pattern. In at least one example embodiment, the camera 221 is a 2D camera. It should be understood that the exact arrangement of the components of observation system 217 are for illustrative purposes, and that the arrangement of the components may vary in alternative embodiments without straying from the scope of the present disclosure.

FIG. 2E illustrates an example scenario in which observation system 217 is tilted relative to the target surface 225. Observation system 217 may view the target surface 225 by emitting a light directly from a forward position of the system 217, which is illustrated as viewing direction 231. The viewing direction 231 meets the target surface 225 at an angle, which is not perpendicular to the target surface 225. Instead, a viewing direction 229 is directly perpendicular to the target surface 225. The difference between the viewing direction 229 and the viewing direction 231 is a tilt angle 227. The tilt angle 227 will be detected by the observation system and a correction of the alignment will be necessary, such that the observation system 217 is in a proper position for detecting surface vibrations.

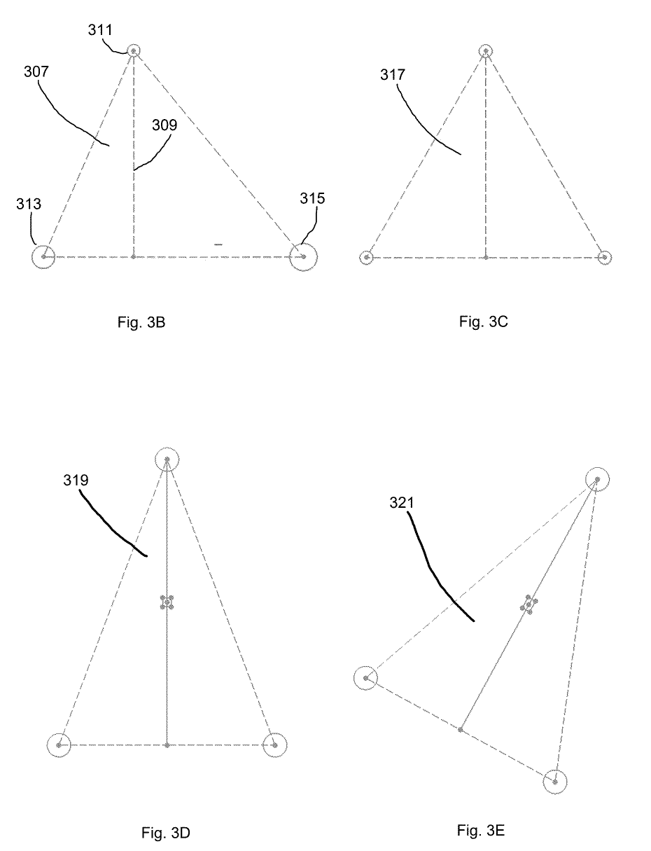

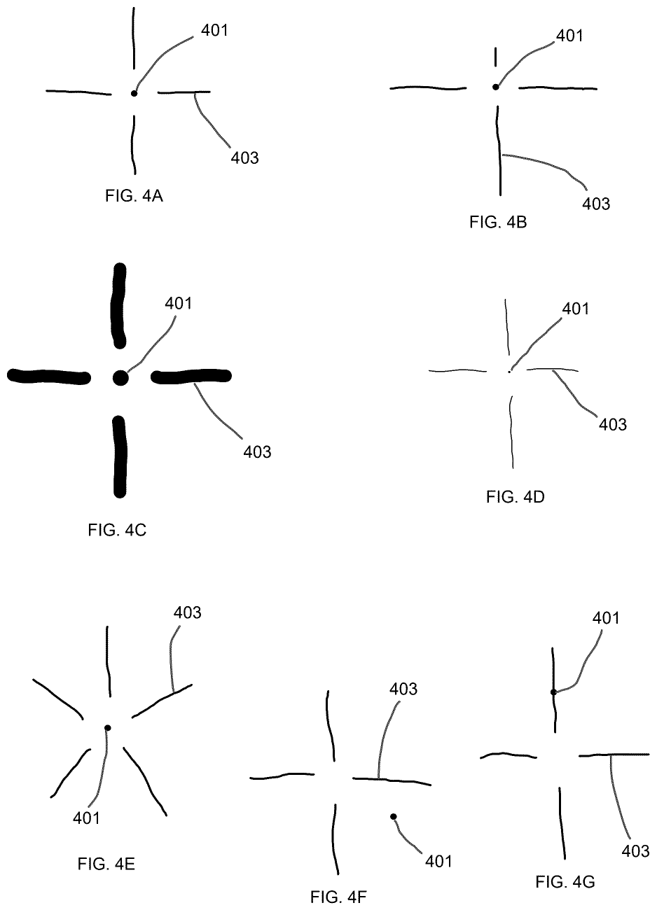

As described above, in relation to method 100, it is important that the observation system is correctly aligned. FIGS. 3A-4G illustrate a series of example scenarios in which various patterns of illumination on a surface are recognized at various angles while conducting the method 100 according to at least one example embodiment.

FIGS. 3A-3E illustrate example light patterns illustrated on a surface that may be used for alignment of the observation system. At least one ancillary light source may be utilized to project the light patterns onto the object surface. As illustrated, the light pattern may include a series of dots positioned in the shape of a triangle.

FIG. 3A illustrates three different triangles representing the observation system being aligned at three different distances from the target surface. Triangle 301 is in a proper position, triangle 303 is viewed at a position too close to the target surface, and triangle 305 is viewed at a position too far from the target surface. The dots forming the points of the triangle may be utilized as an indicator of distance, with the dots being at a minimum size and sharp focus when properly positioned, and the dots being larger and less focused if the observation system is out of focus. The difference in dot patterns is further described below.

FIGS. 3B and 3C each illustrate a triangle being viewed by the observation system. Triangle 307 and triangle 317 are formed from the same ancillary light pattern projection. However, triangle 307 is illustrated as being tilted about an axis 309, while triangle 317 is illustrated in a proper position. As illustrated, alignment dot 311 is focused and at a minimum size, because the top portion of the triangle 307 is not affected by a tilt about axis 309. However, target dots 313 and 315 are shown as being larger and less focused, because target dots 313 and 315 are too close and too far from the observation system, respectively, due to the tilt about axis 309. Further, the triangle formed by the dots in triangle 307 is distorted relative to the ideal formed in triangle 317. As a result, dot size, dot relative positions, or a combination of both can be used to infer alignment or misalignment. Once position of the observation system is corrected, then the target dots all are indicated as minimum size, properly spaced, and properly focused, as shown with regard to triangle 317.

FIGS. 3D and 3E illustrate an additional example of a triangle that may be utilized for alignment of the observation system. Triangle 319 is an isosceles triangle oriented in a proper position. The triangle 321 is in a rotated position relative to the observation axis Z, indicating that the observation system needs to rotate in order to achieve proper alignment. When viewing rotational position, an isosceles triangle may be preferable to an equilateral triangle, as an equilateral triangle would be viewed the same upon a rotation of 120 degrees. In alternative embodiments, the dot pattern may change such that an equilateral triangle may still be utilized to view a rotational discrepancy. It should be appreciated that, although each example of dot patterns is shown as a triangle, alternative shapes, as well as numbers and sizes of dots, such as any type of polygon, for example, may be utilized without straying from the scope of the present disclosure.

FIGS. 4A-4G illustrate additional example light patterns illustrated on a surface that may be used for alignment of the observation system. At least one ancillary light source may be utilized to project the light patterns onto the object surface. As illustrated, the light pattern may include a series of dots and lines, being a center target dot 401 and a number of alignment lines 403.

FIG. 4A illustrates an example in which the observation system is properly aligned, with the target dot 401 being central in a series of alignment lines 403. FIG. 4A shows an example for a target image for which the alignment lights are to be compared to when determining alignment. FIG. 4B illustrates an example in which the object surface has a rearward tilt, thus distorting the lines and creating a discrepancy from the position illustrated in FIG. 4A. Due to the rearward tilt, less of the top alignment line 403 can be observed. FIG. 4C illustrates an example in which the observation system is too close to the object surface. Due to the observation system being too close to the object surface, the dot 401 and lines 403 appear larger than the proper alignment. Conversely, FIG. 4D illustrates an example in which the observation system is too far from the object surface, thus causing the dot 401 and lines 403 to appear smaller than in a proper alignment. FIG. 4E illustrates an example in which an alternative line 403 configuration is utilized in a proper position, the alternative line configuration including five lines 403. FIGS. 4F and 4G illustrate examples in which the dot 401 and lines 403 are independently projected, such that the alignment of the lines must coincide with a central target dot 401 position. FIGS. 4F and 4G indicate an improper alignment, as the target dot 401 is not in a central position relative to the lines 403. As noted above, it should be understood that variations in lines and dots may be utilized in alternative embodiments without straying from the scope of the present disclosure.

Some of the additional characteristics of the image of the illuminated spot on the target surface that change in response to the movement of that surface are described here. The light beams 209 projected onto the target surface can be either collimated or varying in width. These variations can be either increasing or decreasing. For light beams 209 of varying width, the dimensions of the beam 209 change linearly with the distance from the source 201 of the beam 209. Since the distance from the source 201 to the target at equilibrium will be accurately known (see below), the size and configuration of the illuminated spot on the target can be calculated. Deviations from the equilibrium size and configuration will be linearly proportional to changes in the position of the target surface relative to the observing apparatus. To illustrate, if z₀ is the equilibrium distance between the illumination source 201 and the illuminated spot on the target surface, and w₀ is the equilibrium width of the image of the illuminated spot on the detector, then a change, d, in the width of the image corresponds to a change in distance to the target surface of (d/w0)*z₀. The direction of the change depends on whether the light beam increases or decreases in width with respect to distance.

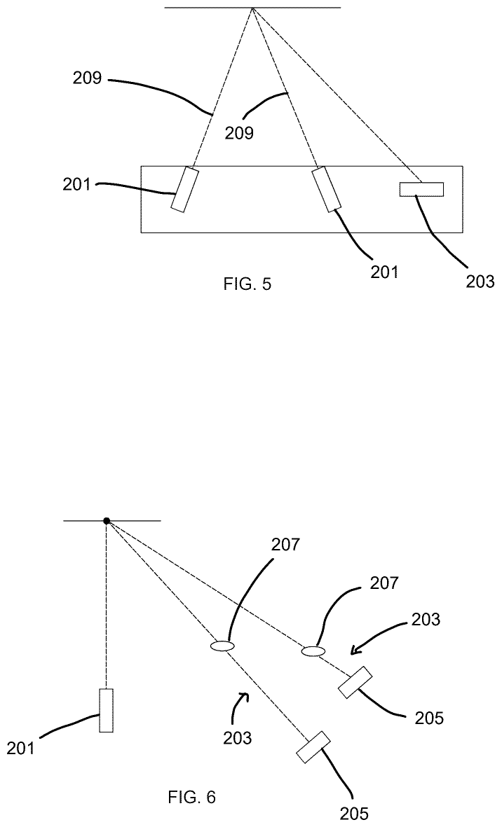

In at least one example embodiment, in order to facilitate the optimal placing of each observation system relative to the target surface, multiple angled light sources 201, associated with a detector 203, can be used so that the light beams 209 originating from each source 201 converge at a specified predefined distance in order to accurately and precisely determine the relevant distances between the target surface and the optical observation system. FIG. 5 illustrates this point. Additionally, non-converging light sources 201 can be used to establish angular orientation of the detector 203 relative to the plane parallel to the surface being measured via measurement of the distances between the light spots on the surface induced by the light sources, which can be used to determine the angular orientation and/or the distance to the surface via geometric relations such as triangulation. Angular orientation can also be determined via shape of the spots, which for instance could be circular when the observation system is perpendicularly aligned with the target surface and elliptical when not. Similarly, the size of the spot could be used to infer distance. Further focus could be used as well where a spot would be in focus at the desired distance and out of focus otherwise. Structured spots could be used as well that would facilitate determining size and/or degree of focus at a desired distance and/or shape at a desired angular orientation.

In at least one example embodiment with multiple light sources 201, the reflected beams from the different sources 201 would be imaged in different locations on the detector 203 chip. The x and y coordinates of the image for each source 201, under static conditions, would be determined by activating each light source 201 individually prior to the dynamic test, and storing the information for reference. Deviations from these positions under dynamic tests could then be associated with the correct light source tracked. The position of the reflected light incident on the detector 203 is captured by the light detector, and changes in position of the reflected light incident on the detector 203 are measured over time.

As described earlier, in relation to the alignment of the observation system, to further aid the user in locating the observation system the optical detector 203 can be configured to recognize the point at which convergence of the light beams is achieved and trigger a flashing light system to alert the user that the optical observation system is properly located. In addition, again, audio signals can be used to help the user properly position the observation system.

Similarly discussed above, the use of the position of the image of the illuminated spot on the detector 203 in order to determine, and, possibly, adjust the distance between the observation system and the target to the desired optimum distance. Because the position of the image is a function of the relationship between the lateral separation (x-distance) and the vertical separation (z-distance) between the illuminated spot on the target and the detector, the position of the image provides the information needed to determine the stand-off distance. At least FIGS. 2A and 2B illustrate the ways in which the geometric relationships between lateral and vertical separation of the illuminated spot may vary.

Again, these systems can be configured so that they can recognize whether the observation system is too close to, too far from, or improperly angled to the target surface and use distinct audio signals to inform the user.

Converging light beams can also be used to generate different interference patterns on the detector chip 203, thus mitigating the effects of laser speckle. The light sources 201 can also be placed at different distances or angles to further reduce the unwanted interference effects. Different light frequencies can also be used to reduce undesired speckle effects.

It may be desirable to maximize the signal-to-noise ratio on the detector chip subject to the constraint that the chip does not go into saturation. In order to maintain the maximum signal intensity short of saturation, it can be necessary to control the output of the illumination source dynamically. This can be done through the use of variable shutter times guided by feedback from the detector chip 203 and/or variable power applied to the light sources 201. If several optically sensitive elements go into saturation, the output can be reduced. If the peak intensities drop too far below saturation, the output can be adjusted upward.

In at least one embodiment, the observation system can be composed of multiple detectors 203 configured to measure motion on different distance scales, with the multiple detectors 203 observing a single illuminated spot on the target surface. Each detector 203 system consisting of various arrangements of a lens or lenses 207 and detector chips 205 is adapted to various distance scales. This can be achieved by using lenses 207 or other imaging devices with different focal lengths, and, hence, different image distances. These variations enable the detection of very fine-grained and relatively coarse grained motions of the target surface. One possible arrangement is depicted in FIG. 6.

Prior to any testing, a 3-dimensional model of the surface could provide an estimate of the signals that would be received at each test location. It could also provide the basis for an algorithm that would predict the variation in the signals in response to various disturbances. Prior to an active test in which various external forces would be applied to the surface, a static survey could be conducted by moving the emitter-detector arrangement in several different ways. The arrangement described above could be moved slowly by some appropriate actuator(s). Small movements toward and away from the target surface, along with movements in the other two dimensions, would enable one to determine the alteration in the signals that would occur with high-frequency disturbances of the surface. Small rotations of the apparatus would provide information about the effect that changes in the angle of the surface would have on the received signals. Essentially, these tests while the surface remains stationary would provide a “slow-motion” version of what to expect during a dynamic test. The information gathered in this way could be compared to the 3-dimensional model, and used to develop (or refine) a tracking algorithm that would predict how the pattern of illumination would move across the detector in response to various disturbances. This algorithm would be used to achieve a sufficiently high sample rate by indicating which subset of pixels should be selected in the next sampling time.

In one aspect of this disclosure, a system may be constructed for measuring vibrations on a surface of an object, where the system is comprised of one or more observation devices. The observation device is supported above the point of interest on the surface of an object by a support mechanism. As noted above, the light sources and the light detectors are housed by the observation device and are arranged in a geometric plane that is substantially parallel to the surface of the object. The geometric plane serves as the x-y plane of a Cartesian coordinate system, whereas, an imaginary line drawn from the point of interest to the geometric plane serves as the z axis of the Cartesian coordinate system. For calibration purposes, the support mechanism is configured to adjust the position of the observation device in relation to the surface of the object along five degrees of freedom. That is, position of the observation device can be rotated around the x axis, rotated around the y axis, or translated along any of the three axes of the Cartesian coordinate system. It is envisioned that the position of the observation device can be adjusted manually by an operator or in an automated manner, for example using servo motors. Suitable support mechanisms are readily found in the art. A graphical interface may be used to assist with positioning of the observation device. The graphical interface operates to display current observed position and orientation of the observation device relative to the point of interest on the surface as well as CAD models of the surface. Observing the graphical interface, an operator can adjust the observation device accordingly.

An example calibration and set-up procedure for an observation device is further described. First, establish the correct vertical (z) and planar (X-Y) orientation of a given observation device in order to aim the focal point of the observation device onto the point of interest on the surface under investigation. To do so, adjust the support mechanism to achieve X and Y orientation of the base plane of the observation device in order that it would be parallel to the X-Y plane (or perpendicular as derived from average of the slopes in the case of observing an acutely peaked at its zenith) of the surface at the point of interest, for example by manipulating the supporting fixture orientation-adjustment mechanisms. After completing this step, adjust the distance along the vertical z axis between the base plane of the observation device and that of the surface at the point of interest, for example by means of a rack-and-pinion gear-set. Drawing upon the surface topography provided by 3-D renderings, such as CAD, photogrammetric files or high-resolution photographic images, the operator can make judgements for the selection of the desired point of interest on the surface.

To observe and quantify the effect of undesired external (uncontrolled) sources of mechanical excitation acting upon the surface under investigation, one can initiate projection of light from the light sources at a defined level of intensity onto the surface under investigation at the desired point of interest, in order to accurately quantify what, if any acoustic excitation is being conveyed onto the surface by uncontrolled external forces. In the course of this static characterization procedure, the frequency content, amplitude, and velocity of such external excitation is quantified.

To quantify the effect of undesired external (uncontrolled) sources of illumination that may interfere with correct observation by the light detectors, one can initiate projection of light from the light sources at a defined level of intensity onto the surface under investigation. To determine the effects of any stray light at the desired point of interest, compare the detected level of illumination received by each of the light detectors in the observation device by subtracting the level of projected illumination from each of the light sources.

To ensure accurate correspondence between emitter 201/detector 203 pairs, intensity of the light emitted from the light sources 201 may be modulated with different pre-defined patterns of frequency variation.

As noted above, a display device may be interfaced with the processor. During an investigation, a priori CAD or photographical representation of the surface can be displayed on to the device. Metrics related to vibrations experienced by the surface of the object and observed by the system can also be displayed on the display device. In some embodiments, vibrations, including the different propagating waves, experienced by the surface are animated, or otherwise visualized (e.g., using a waterfall illustration), on a graphical user interface.

The computational and measurement techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware, or hardware, and when embodied in software, could be downloaded to reside on, and be operated from, different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A non-contact sensing method for measuring vibrations of a surface of an object with an observation system, comprising:
positioning an observation system proximate to the surface of the object, where the observation device is configured to measure vibration of the surface using one or more primary light sources and includes at least one ancillary light source for alignment;
projecting an alignment pattern onto the surface of the object using the at least one ancillary light source; and
adjusting position of the observation system in relation to the surface of the object based on the alignment pattern projected onto the surface of the object.

2. The method of claim 1 wherein the alignment pattern is further defined as a central point having a number of lines emanating from the central point.

3. The method of claim 1 wherein the alignment pattern is further defined as a polygon generated by three or more ancillary light sources.

4. The method of claim 1 wherein the position of the observation system is adjusted by an operator of the observation system.

5. The method of claim 1 wherein adjusting position of the observation system includes detecting the alignment pattern reflected by the surface of the object using at least one detector associated with the observation system; comparing the detected alignment pattern to an expected alignment pattern; and automatically adjusting position of the observation system based on the comparison of the detected alignment pattern to the expected alignment pattern.

6. The method of claim 1 further comprises generating at least one of an audible indicator or a visible indicator in response to alignment of the observation system with the surface of the object.

7. The method of claim 1 further comprises
projecting light from the one or more primary light sources towards an area of interest on the surface of an object, where the light projected from the one or more light sources is incident on at least one point on the surface of the object;
detecting the light reflected by the surface of the object using one or more detectors associated with the observation system;
for each of the one or more detectors, determining a change in position of the reflected light detected by the detector over time;
for the at least one point on the surface of the object, calculating a series of measurements of vertical displacement of the surface over a period of time from the change in position of the reflected light and using triangulation; and
determining frequency of a disturbance of the surface at the at least one point on the surface and an amplitude of the disturbance using the series of measurements of vertical displacement.

8. The method of claim 1 further comprises
projecting light from a first primary light source and a second primary light source of the one or more primary light sources towards an area of interest on the surface of an object, where the light projected from the one or more light sources converge at a predefined distance, so as to accurately and precisely determine a distance between the area of interest on the surface of the object and the observation system.

9. The method of claim 1 wherein the alignment pattern is projected onto the surface of the object using the one or more primary light sources and the at least one ancillary light source.

10. An observation system for measuring vibrations of a surface of an object, comprising:
one or more primary light sources configured to measure vibration of the surface of the object;
at least one ancillary light source configured to project an alignment pattern onto the surface of the object; and
at least one adjustment mechanism configured to adjust position of the observation system in relation to the surface of the object based on the alignment pattern projected onto the surface of the object.

11. The observation system of claim 10 wherein the alignment pattern is defined as a central point having a number of lines emanating from the central point.

12. The observation system of claim 10 wherein the alignment pattern is defined as a polygon generated by three or more ancillary light sources.

13. The observation system of claim 10 wherein the adjustment mechanism is configured to be adjusted by an operator of the observation system.

14. The observation system of claim 10 further comprising
at least one detector configured to detect the alignment pattern reflected by the surface of the object;
wherein the adjustment mechanism is configured automatically adjust position of the observation system based on a comparison of the detected alignment pattern to an expected alignment pattern.

15. The observation system of claim 10 wherein the adjustment mechanism further comprises at least one of an audible indicator or a visible indicator, the audible indicator and the visible indicator being configured to be activated in response to alignment of the observation system with the surface of the object.

16. The observation system of claim 10 further comprising
one or more detectors configured to detect light produced by the one or more primary light sources and reflected by the surface of the object, such that a change in position of the reflected light detected by each of the one or more detectors is determined; and
at least one processor configured to
calculate a series of measurements of vertical displacement of the surface over a period of time from the change in position of the reflected light; and
determine frequency of a disturbance of the surface at one or more points on the surface and an amplitude of the respective disturbance using the series of measurements of vertical displacement.

17. The observation system of claim 1 wherein a first primary light source and a second primary light source are configured to each project light toward an area of interest on the surface of the object, and the projected light from each of the first primary light source and the secondary light source converge at a predefined distance, so as to determine a distance between the area of interest on the surface of the object and the observation system.

18. The observation system of claim 10 wherein the alignment pattern includes light from the one or more primary light sources and the at least one ancillary light source.
